(19) United States
(12) Patent Application Publication
(10) Pub. No.: US 2011/0072823 A1
(43) Pub. Date: Mar. 31, 2011

(54) GAS TURBINE ENGINE FUEL INJECTOR

(76) Inventors: Daih-Yeou Chen, San Diego, CA (US); Xiaolan Hu, San Diego, CA (US)

(21) Appl. No.: 12/570,103

(22) Filed: Sep. 30, 2009

(51) Int. Cl. F02C 7/22

(52) U.S. Cl. 60/742

(57) ABSTRACT

An example gas turbine engine fuel injector nozzle assembly includes a nozzle tip secured relative to a combustion area within a gas turbine engine. The nozzle establishes a plurality of first apertures that are configured to communicate a fuel to the combustion area. The nozzle establishes at least one second aperture that is configured to communicate a fluid to the combustion area. The fluid is different than the fuel. An example method of providing fuel to a combustion area within a gas turbine engine includes communicating a fuel through a first aperture in a nozzle tip to a combustion area in a gas turbine engine. The nozzle tip establishes an axis. The method also includes influencing fuel moving from the nozzle tip using a fluid directed through a second aperture in the nozzle tip. The fluid is different than the fuel. A portion of the second aperture is radially closer to the axis than the first aperture.

### BACKGROUND

This application relates generally to dispersing fuel within the combustor section of a gas turbine engine.

Gas turbine engines are known and typically include multiple sections, such as an inlet section, a compression section, a combustor section, a turbine section, and an exhaust nozzle section. The inlet section moves air into the engine. The air is compressed in the compression section. The compressed air is mixed with fuel and is combusted in combustion areas within the combustor section. The products of the combustion expand to rotatably drive the engine.

The combustor section of the gas turbine engine typically includes injectors that deliver fuel and air to the combustion areas. Poorly mixed fuel and air, or a high fuel to air ratio, can result in fuel-rich pockets within the combustion areas, which can undesirably increase smoke emissions from the engine. Atomizing fuel delivered to the combustion areas desirably reduces smoke emissions, especially in Rich-Quench-Lean (RQL) combustors. Atomizing the fuel reduces the fuel to small particles.

Some prior art injectors atomize the fuel delivered to the combustors using swirlers, such as vanes mounted to the injector. As known, the swirler-typed injectors often cannot typically be used in gas turbine engines that need to meet more stringent cold high altitude starting requirements. Referring to Prior Art FIG. 1, a prior art injector 100 discharges fuel through a single tube 114 into the combustor area. Air moves through a single passage 118 that surrounds the tube 114. As known, these prior art injectors limit of the shear layer area between the air and the fuel resulting in non-uniform fuel atomization and poor fuel/air mixing, especially near the centerline of the passage 118. Such a design can undesirably increase the smoke and nitrous oxide emissions of the engine.

### SUMMARY

An example gas turbine engine fuel injector nozzle assembly includes a nozzle tip secured relative to a combustion area within a gas turbine engine. The nozzle establishes a plurality of first apertures that are configured to communicate a fuel to the combustion area. The nozzle establishes at least one second aperture that is configured to communicate a fluid to the combustion area. The fluid is different than the fuel. The fluid is air in one example.

An example gas turbine engine fuel injector assembly includes a housing mountable relative to a combustion area within a gas turbine engine, a nozzle tip secured to the housing and establishing an axis, and a fuel conduit configured to communicate a fuel through the housing to the nozzle tip. First apertures in the nozzle tip are circumferentially distributed about the axis and are each configured to communicate some of the fuel from the fuel conduit to the combustion area. At least one of the housing or the nozzle tip establishes a second aperture that is configured to communicate a fluid that is different than the fuel to the combustion area. The fluid is air in one example.

An example method of providing fuel to a combustion area within a gas turbine engine includes communicating a fuel through a first aperture in a nozzle tip to a combustion area in a gas turbine engine. The nozzle tip establishes an axis. The method also includes influencing fuel moving from the nozzle tip using a fluid directed through a second aperture in the nozzle tip. The fluid is different than the fuel. A portion of the second aperture is radially closer to the axis than the first aperture. The fluid is air in one example.

These and other features of the example disclosure can be best understood from the following specification and drawings, the following of which is a brief description:

### BRIEF DESCRIPTION OF THE DRAWINGS

FIG. 1 shows a sectional view of a prior art injector.

FIG. 2 is a schematic view of an example gas turbine engine.

FIG. 3 shows partial sectional view of the combustor section of the FIG. 2 engine.

FIG. 4 shows a perspective view of the FIG. 3 injector with some portions removed.

FIG. 5 shows a sectional view through line 5-5 of the FIG. 3 injector.

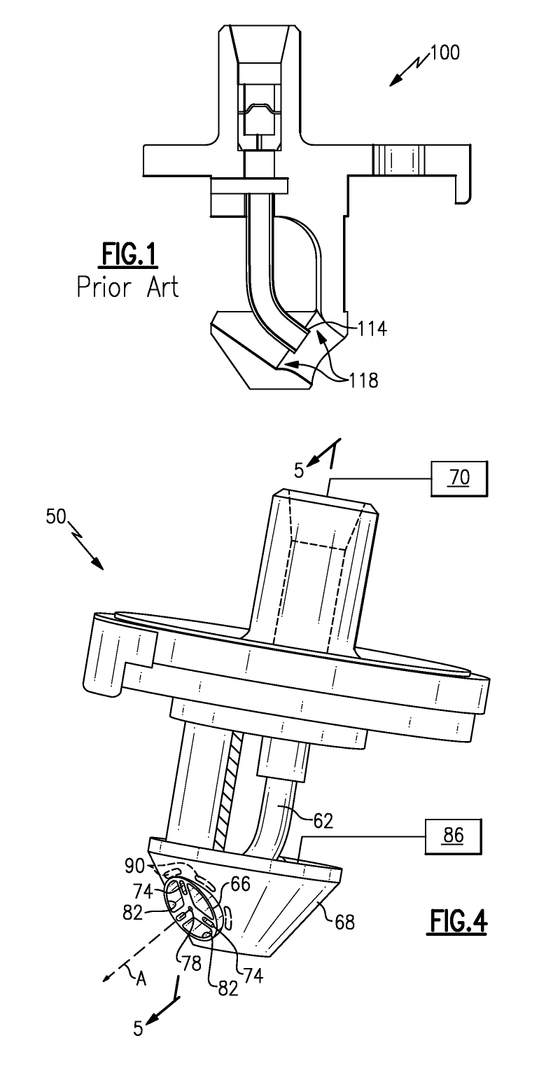

### DETAILED DESCRIPTION

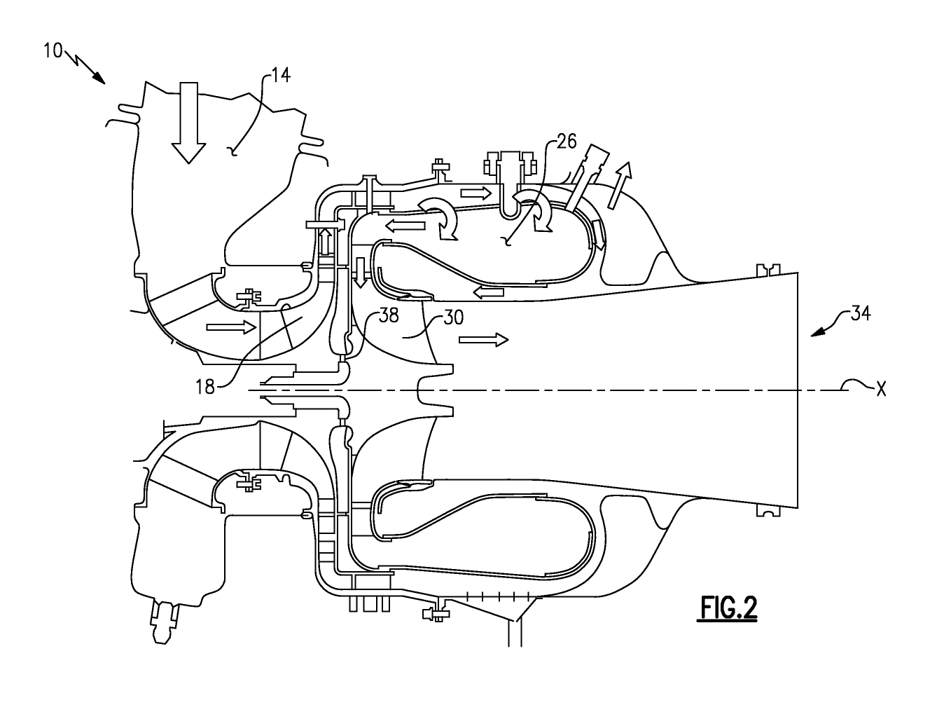

FIG. 2 schematically illustrates an example gas turbine engine 10 including (in serial flow communication) an inlet section 14, a centrifugal compressor 1, a combustor section 26, a turbine wheel 30, and a turbine exhaust 34. The gas turbine engine 10 is circumferentially disposed about an engine centerline X₁. During operation, air is pulled into the gas turbine engine 10 by the inlet section 14, pressurized by the compressor 18, mixed with fuel, and burned in the combustor section 26. The turbines wheel 30 extracts energy from the hot combustion gases flowing from the combustor section 26.

In a radial design, the turbine wheel 30 utilizes the extracted energy from the hot combustion gases to power the centrifugal compressor 18. The examples described in this disclosure are not limited to the radial turbine type auxiliary power units described and may be used in other architectures, such as a single-spool axial design, two-spool axial design, a three-spool axial design. That is, there are various types of engines that could benefit from the examples disclosed herein, which are not limited to the radial turbine design shown.

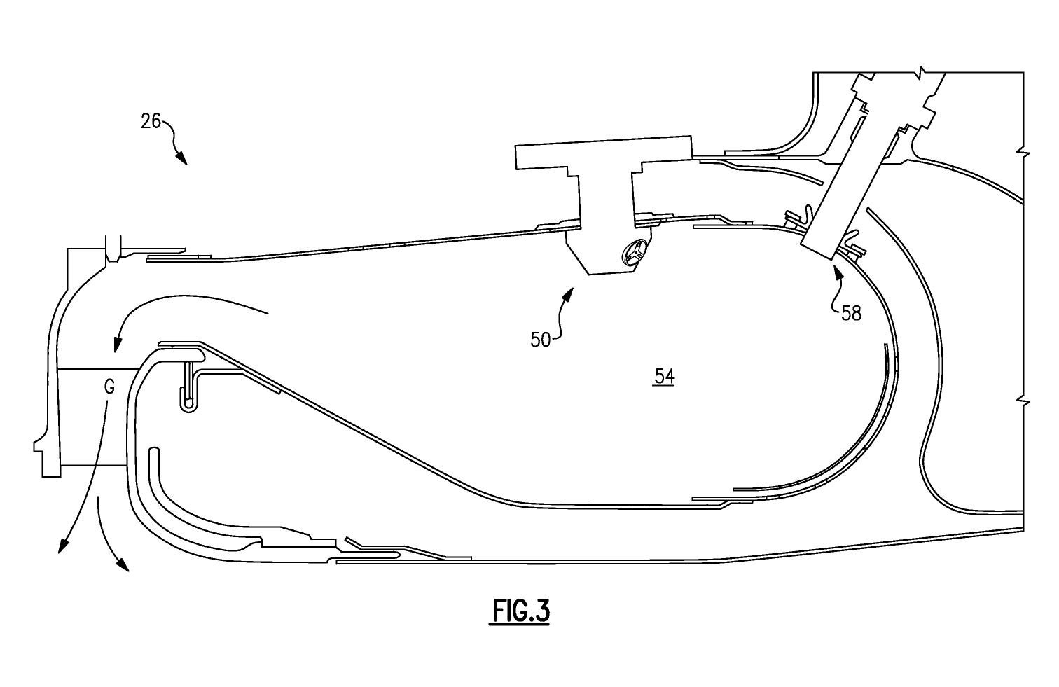

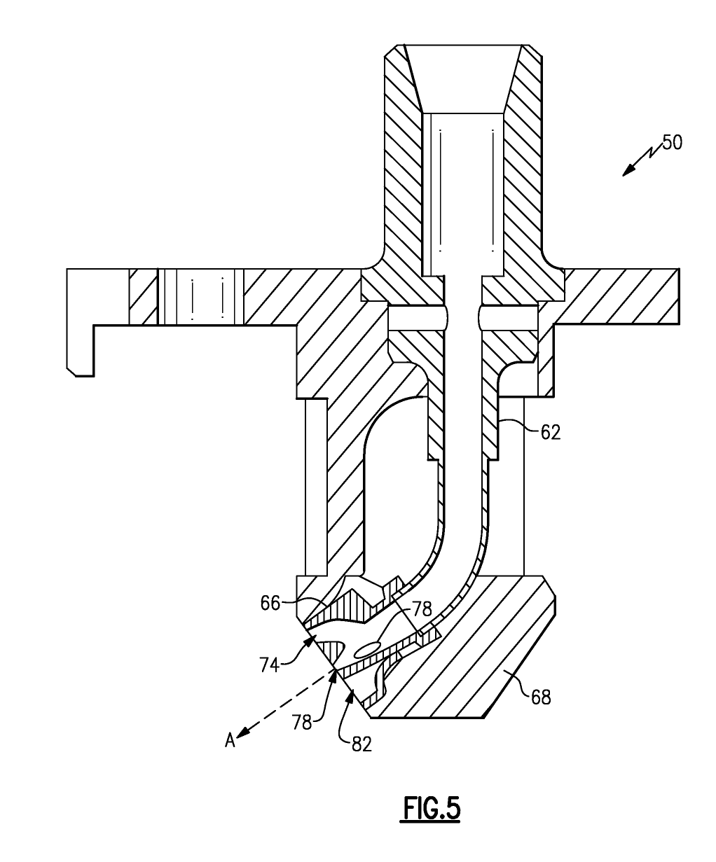

Referring to FIGS. 3-5 with continuing reference to FIG. 2, in the combustor section 26, an example injector 50 communicates fuel and air to a combustion area 54. An ignitor 58 ignites the mixture. The resulting hot combustion gasses G move from the combustion area 54 to the turbine wheel 30 of the engine 10. Fuel, in this example, is a type of ignitable fluid. Example fuels are JETA, JETB, JP4, JPS, JP8, diesel fuels and bio-fuels.

The example injector 50 includes a fuel conduit 62 and a nozzle tip 66. Fuel moves from a fuel supply 70, through the fuel conduit 62, through the nozzle tip 66, to the combustion area 54. The nozzle tip 66 is mounted in a housing 68 of the injector 50.

In this example, at least some of the fuel moves through a plurality of slots 74 in the nozzle tip 66. The slots 74, a type of aperture, are circumferentially arranged about an axis A in an array. The example slots 74 are radially extending. That is, the radial dimension of the slots 74 is greater than the circumferential dimension. This example includes three slots 74 positioned every 120 degrees about the axis A. Internal channels 78, within the nozzle tip 66, communicate fuel from the fuel conduit 62 to each of the plurality of slots 74.

In this example, at least some of the fuel also moves to the combustion area 54 through an aperture 78 in the nozzle tip 66. The example aperture 78 is aligned with the axis A and has a circular cross-sectional profile.

The nozzle tip 66 establishes a plurality of apertures 82 that communicate air, another type of fluid, from an air supply 86 to the combustion area 54. In this example, an array of the apertures 82 is circumferentially arranged about the axis. Each of the apertures 82 has a triangular cross-sectional profile. This example includes three apertures 82 positioned every 120 degrees about the axis A.

The slots 74 and the apertures 82 alternate in this example. That is, one of the slots 74 is positioned circumferentially between two of the apertures 82, and one of the apertures 82 is positioned circumferentially between two of the slots 74. The apertures 82 also extend radially closer to the axis A than the slots 74. The array of the slots 74 is thus circumferentially offset from the array of the apertures 82.

In this example, air communicates though the apertures 82 to atomize fuel exiting the nozzle tip 66 through the slots 74. In another example, air communicates though other apertures in the housing, such as apertures (not shown) at locations 90, to atomize the fuel exiting the nozzle tip 66 though the slots 74. Air communicates through the other apertures instead of, or in addition to, the apertures 82.

The example nozzle tip 66 is brazed or welded to the housing 68. Other examples secure the nozzle tip 66 to the housing 68 using other methods of attachment. The nozzle tip 66 is IN625 steel in this example.

Features of the disclosed examples include communicating fuel to a combustion area through multiple apertures in a nozzle tip to facilitate atomizing the fuel using air.

Although a preferred embodiment has been disclosed, a worker of ordinary skill in this art would recognize that certain modifications would come within the scope of this invention. For that reason, the following claims should be studied to determine the true scope and content of this invention.

We claim:

1. A gas turbine engine fuel injector nozzle assembly comprising:
a nozzle tip secured relative to a combustion area within a gas turbine engine, the nozzle establishing a plurality of first apertures configured to communicate a fuel to the combustion area, the nozzle tip establishing at least one second aperture configured to communicate a fluid to the combustion area, the fluid different than the fuel.

2. The gas turbine engine injector nozzle assembly of claim 1 wherein the fluid is air.

3. The gas turbine engine injector nozzle assembly of claim 1 wherein the nozzle tip establishes a plurality of second apertures.

4. The gas turbine engine injector nozzle assembly of claim 3 wherein the plurality of first apertures are arranged in a first array, and the plurality of second apertures are arranged in a second array that is circumferentially offset from the first array.

5. The gas turbine engine injector nozzle assembly of claim 1 wherein the nozzle tip establishes an axis, wherein one of the plurality of first apertures is aligned with the axis and the at least one second aperture is radially spaced from the axis.

6. The gas turbine engine injector nozzle assembly of claim 1 wherein the cross-sectional area of one of the at least one second apertures is larger than the cross-sectional area of one of the plurality of first apertures.

7. The gas turbine engine injector nozzle assembly of claim 1 wherein the nozzle tip establishes more than two first apertures and more than two second apertures.

8. The gas turbine engine injector nozzle assembly of claim 1 wherein the second apertures have a triangular cross-section.

9. A gas turbine engine fuel injector assembly comprising:
a housing mountable relative to a combustion area within a gas turbine engine;
a nozzle tip secured to the housing and establishing an axis; and
a fuel conduit configured to communicate a fuel through the housing to the nozzle tip, wherein a plurality of first apertures in the nozzle tip are circumferentially distributed about the axis and are each configured to communicate some of the fuel from the fuel conduit to the combustion area, wherein at least one of the housing or the nozzle tip establishes at least one second aperture that is configured to communicate a fluid that is different than the fuel to the combustion area.

10. The gas turbine engine injector assembly of claim 9 wherein the at least one second aperture extends radially closer to the axis than the plurality of first apertures.

11. The gas turbine engine injector assembly of claim 9 wherein the fluid is air.

12. The gas turbine engine injector assembly of claim 9 wherein the nozzle tip has a circular cross-section.

13. The gas turbine engine injector assembly of claim 9 wherein the fuel communicates through the nozzle tip in direction that is aligned with the axis.

14. The gas turbine engine injector assembly of claim 9 including a third conduit coaxially aligned with the axis, the third conduit configured to communicate some of the fuel to the combustion area.

15. The gas turbine engine injector assembly of claim 9 wherein the fluid communicated from the at least one second aperture influences a flow of the fluid communicated from the plurality of first apertures to the combustion area.

16. A method of providing fuel to a combustion area within a gas turbine engine comprising:
communicating a fuel through a first aperture in a nozzle tip to a combustion area in a gas turbine engine, the nozzle tip establishing an axis; and
influencing fuel moving from the nozzle tip using a fluid directed through a second aperture in the nozzle tip, the fluid different than the fuel, at least a portion of the second aperture is radially closer to the axis than the first aperture.

17. The method of providing fuel to a combustion area within a gas turbine engine of claim 16 wherein the fluid is air.

18. The method of providing fuel to a combustion area within a gas turbine engine of claim 16 wherein the fluid atomizes the fuel moving from the nozzle tip.

19. The method of providing fuel to a combustion area within a gas turbine engine of claim 16 including communicating fuel through a third aperture in a nozzle tip to the combustion area, the third aperture coaxially aligned with the nozzle tip.
